(19) United States
(12) Patent Application Publication
(10) Pub. No.: US 2025/0199282 A1
(43) Pub. Date: Jun. 19, 2025

(54) DIGITAL SLIDE MICROSCOPIC SCANNING APPARATUS AND SLIDE MICROSCOPIC SCANNING METHOD

(71) Applicant: MARKETECH INTERNATIONAL CORP., Taipei City (TW)

(72) Inventors: Li-Cheng HSU, Zhudong Township (TW); Yen-Chung CHEN, Hsinchu City (TW); Hung-Yi HUANG, Xinpu Township (TW); Yu-Min LI, Taoyuan City (TW)

(21) Appl. No.: 18/538,350

(22) Filed: Dec. 13, 2023

(51) Int. Cl. G02B 21/00; G01N 35/10; G06V 20/69; H04N 23/90

(52) U.S. Cl. CPC G02B 21/0036; G01N 35/10; G02B 21/008; G06V 20/693; H04N 23/90

(57) ABSTRACT

Disclosed is a digital slide microscopic scanning apparatus and a slide microscopic scanning method. The digital slide microscopic scanning apparatus has a sample library, a transfer device, and a scanning device. The transfer device is used to transfer slides containing biological microtissues between the sample library and the scanning device. The scanning device has a first camera and a second camera. The first camera scans the slide full-frame at a lower first magnification to obtain a first microscopic image and determines the target area of the slide based on this first microscopic image. The second camera scans this target area at a higher magnification to obtain a second microscopic image. Both the first and second microscopic images are acquired rapidly, and the size of data in the converted first digital file and the second digital file is small.

### CROSS-REFERENCE TO RELATED U.S. APPLICATIONS

Not applicable.

### BACKGROUND OF THE INVENTION

### 1. Field of the Invention

The present invention pertains to the field of scanning slides for biological tissue cell detection. More specifically, the present invention relates to a digital slide microscopic scanning apparatus and a slide microscopic scanning method.

### 2. Description of Related Art Including Information Disclosed Under 37 CFR 1.97 and 37 CFR 1.98

In the preservation of micro-tissue samples from biological organisms on microscope slides, digital slide microscopic scanning apparatus microscopically scan these slides to capture images of the samples, which are then digitally stored.

The digital slide scanning apparatus utilizes high-magnification of 20× or 40× to create detailed panoramic micro-scans of the slide, tailored to the specific needs of the sample. While this process is thorough, it is time-consuming due to the high pixel count of the images. Consequently, more time is required to convert these high-resolution images into digital files. In addition, the large file size of these converted digital images is not optimal for quickly scanning a large number of slides or for efficiently copying and transmitting these digital files. Storing a large number of these large digital files can also place a significant burden on the associated storage equipment.

### BRIEF SUMMARY OF THE INVENTION

The main purpose of the present invention is to provide a digital slide microscopic scanning apparatus and a slide microscopic scanning method.

In order to accomplish the foregoing, the present invention employs the following technical solution:

A digital slide microscopic scanning apparatus is provided, comprising a sample library, a transfer device, and a scanning device, wherein the sample library is a storage device for holding multiple slides, each slide carrying a sample of micro-tissue.

The transfer device comprises a robotic arm assembly and a gripper, wherein one side of the robotic arm assembly faces the sample library and the gripper is located on the side of the robotic arm assembly facing the sample library; the robotic arm assembly operates the gripper to extract or insert a selected slide from/to the sample library and transfers the slide between the sample library and the scanning device.

The scanning device, located on one side of the robotic arm assembly, comprises a carrier, a mount, a motor, a first camera, a second camera, and a processing unit, wherein the carrier holds and positions the slide, the first and second cameras and the motor are electrically connected to the processing unit, and both the first and second cameras are located on the side of the mount facing the carrier so that the first and second cameras can respectively scan the slide and transmit the scanned images to the processing unit.

The motor drives the movement of the mount, allowing either the first camera or the second camera to be selectively activated for the purpose of scanning the slide.

The first camera conducts a full-frame scan of the slide at a first magnification to obtain a first microscopic image of the sample, the second camera subsequently conducts a scan of a specifically selected target area of the slide at a second magnification to obtain a second microscopic image of the sample, and these first and second microscopic images are then transmitted by the processing unit, wherein the first magnification is lower than the second magnification.

The processing unit comprises an electronic circuit having at least one microprocessor that executes image recognition software, determines the target area of the slide to be scanned by the second camera based on the first micrographic image, and converts the first micrographic image and the second micrographic image into a first digital file and a second digital file, respectively, in digital form.

A slide microscopic scanning method is disclosed, performed using the digital slide microscopic scanning apparatus discussed above and according to claim 1, comprises the following steps executed in sequence:
slide positioning: the transfer device selects a slide containing the sample from the sample library and transfers it to the carrier;
full-frame scanning: the first camera conducts a full-frame scan of the slide at a first magnification to obtain a first microscopic image of the sample;
identifying the first microscopic image and marking the target area: the microprocessor executes the image recognition software to identify the first microscopic image, at least one distribution area of the cells or tissues of the sample is marked as the target area based on the identified image, and the first microscopic image is converted to a first digital file;
area scanning: the processing unit controls the motor and the mount to operate the second camera, which scans the target area of the slide at a second magnification, obtaining a second microscopic image of the sample, then the processing unit executes the image recognition software to identify the second microscopic image and convert the second microscopic image into the second digital file; and
slide return: the transfer device places the scanned slide back into the sample library.

The present invention efficiently executes a full-frame scan using at the lower first magnification, subsequently scanning the designated target area at the higher second magnification. This approach significantly reduces the time required to acquire images and to convert them into the first and second digital files. The resulting data size of these digital files is notably smaller than prior art, providing a substantial advantage for quickly scanning large numbers of slides. It also facilitates the copying and transmitting of these digital files.

### BRIEF DESCRIPTION OF THE SEVERAL VIEWS OF THE DRAWINGS

FIG. 1 is a perspective view of a preferred embodiment of the digital slide microscopic scanning apparatus of the present invention.

FIG. 2 is a partial perspective view of the same embodiment, showing part of the transfer device.

FIG. 3 is a partial front view of the same embodiment, showing part of the scanning device.

FIG. 4 is a partial perspective view of the scanning device of the same embodiment.

FIG. 5 is a block diagram of the circuitry of the scanning device of the same embodiment.

FIG. 6 is a schematic diagram of the full-frame scanning of a slide.

FIG. 7 is a plan view of the selected target area of the slide.

FIG. 8 is a flowchart of the slide microscopic scanning method of the same embodiment.

FIG. 9 is a partial right side view of the scanning device of another embodiment of the present invention.

### DETAILED DESCRIPTION OF THE INVENTION

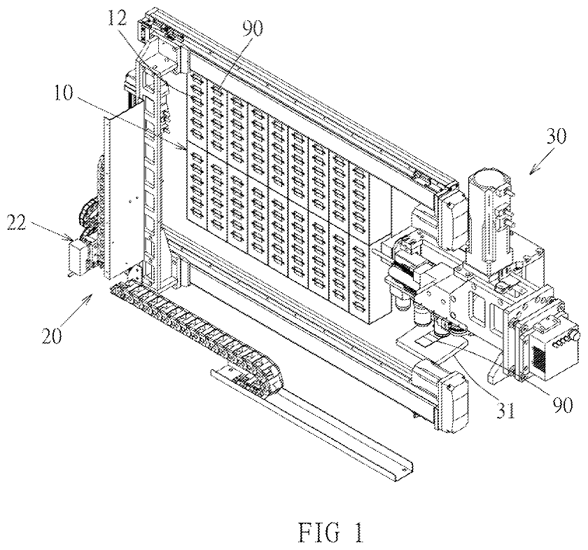

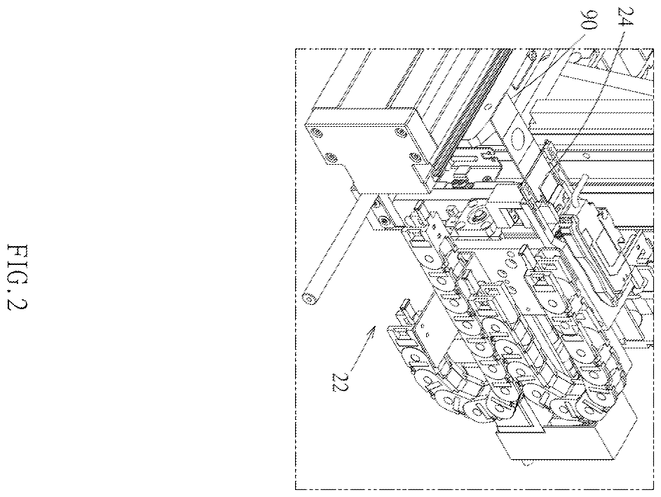

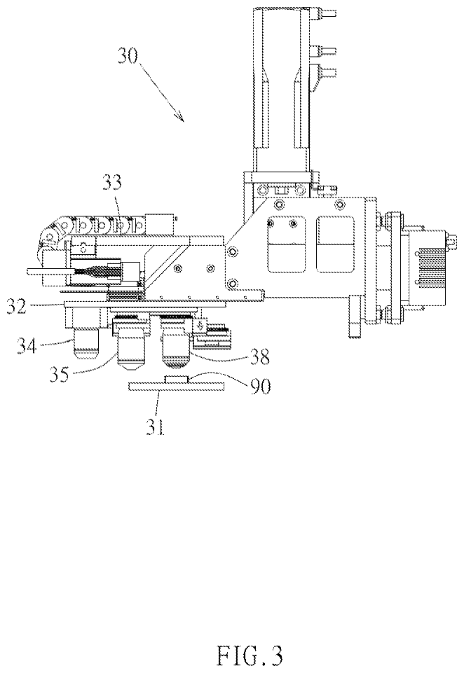

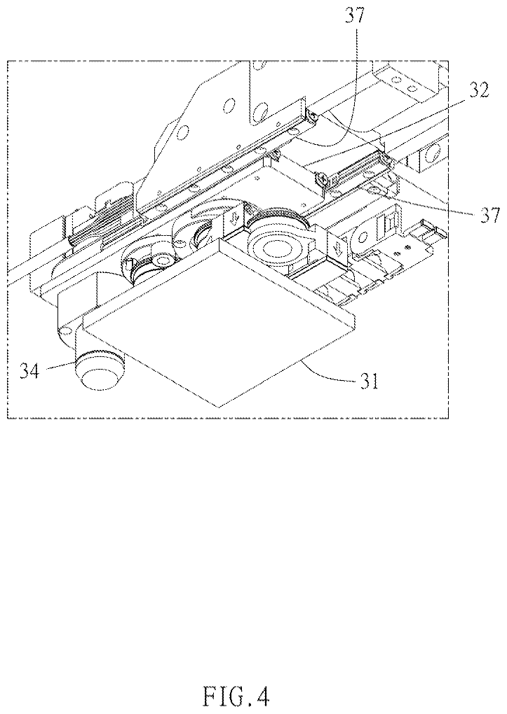

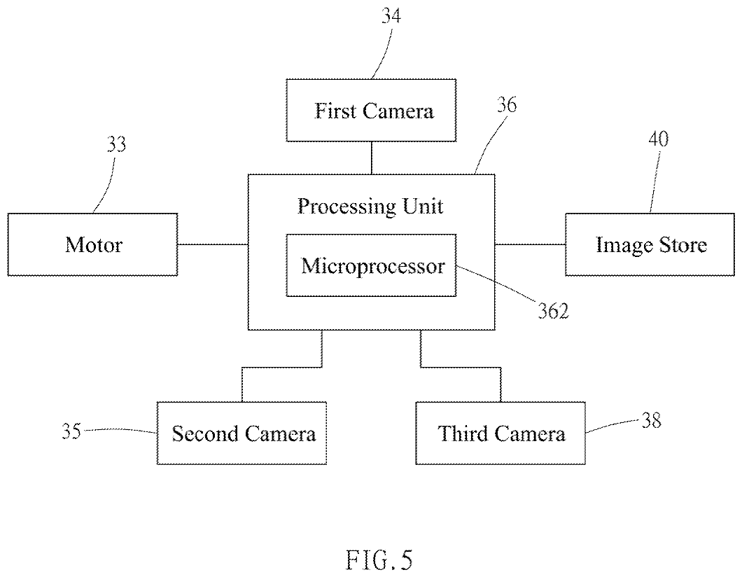

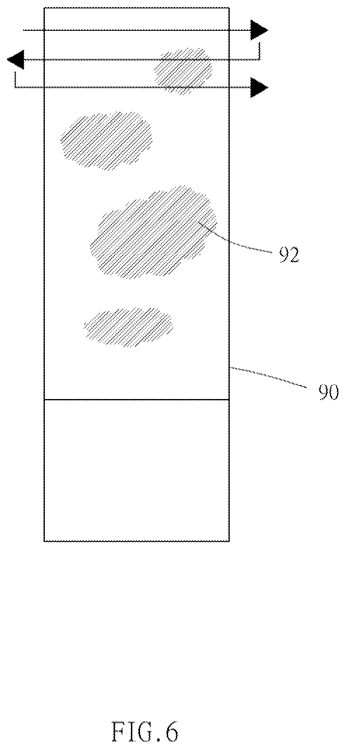

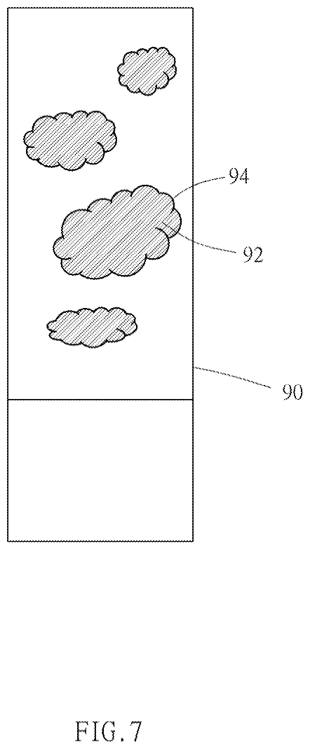

As shown in FIGS. 1 through 7, a digital slide microscopic scanning apparatus comprises a sample library 10, a transfer device 20, and a scanning device 30. The sample library 10 is a storage device for holding multiple slides 90, each slide 90 carrying a sample of micro-tissue 92. The sample library 10 is divided into multiple compartments 12, each slide 90 being arranged in parallel with each other and vertically at sequential intervals within these compartments 12 from top to bottom, thereby enhancing storage space efficiency for multiple slides 90.

The transfer device 20 comprises a robotic arm assembly 22 and a gripper 24, where one side of the robotic arm assembly 22 faces the sample library 10. The gripper 24 is located on the side of the robotic arm assembly 22 facing the sample library 10. The robotic arm assembly 22 operates the gripper 24 to extract or insert a selected slide 90 from/to the sample library 10 and transfers the slide 90 between the sample library 10 and the scanning device 30.

The scanning device 30 is located on one side of the robotic arm assembly 22 and comprises a carrier 31, a mount 32, a motor 33, a first camera 34, a second camera 35, and a processing unit 36. The carrier 31 is responsible for holding and positioning the slide 90, while the mount 32 is situated opposite the side of the carrier 31 that holds the slide 90. Both the first camera 34 and the second camera 35 are located on the side of the mount 32 facing the carrier 31 and are electrically connected to the processing unit 36 so that they can respectively scan the slide 90 and transmit the scanned images to the processing unit 36 for analysis and processing.

Having regard to the fact that the first camera 34 and the second camera 35 are established components familiar to those in the field of the present invention, the specific composition of the first camera 34 and the second camera 35 will not be described in detail.

The motor 33, which is electrically connected to the processing unit 36, drives the movement of the mount 32. This allows either the first camera 34 or the second camera 35 to be selectively activated for the purpose of scanning the slide 90.

The first camera 34 conducts a full-frame scan of the slide 90 at a first magnification to obtain a first microscopic image of the sample 92. Subsequently, the second camera 35 conducts a scan of a specifically selected target area 94 of the slide 90 at a second magnification to obtain a second microscopic image of the sample 92, and these first and second microscopic images are then transmitted by the processing unit 36. In this particular embodiment, the first magnification is lower than the second magnification, the first magnification being set at 4×, while the second magnification is higher, set at 20×.

The processing unit 36 comprises an electronic circuit having at least one microprocessor 362 that executes image recognition software, is electrically connected to each of the first camera 34 and the second camera 35, determines the target area 94 of the slide 90 to be scanned by the second camera 35 based on the first micrographic image, and converts the first micrographic image and the second micrographic image into a first digital file and a second digital file, respectively, in digital form.

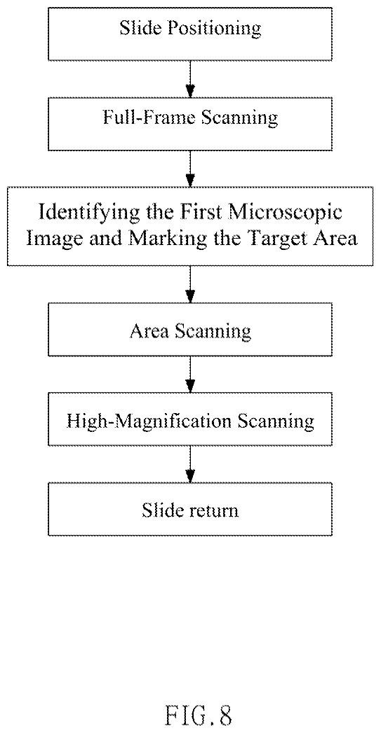

As shown in FIG. 8, the slide microscopic scanning method performed using the aforementioned digital slide microscopic scanning apparatus includes the following steps executed in sequence:

Slide positioning: The transfer device 20 selects a slide 90 containing the sample 92 from the sample library 10 and transfers it to the carrier 31.

Full-frame scanning: The first camera 34 conducts a full-frame scan of the slide 90 at the first magnification to obtain the first microscopic image of the sample 92. Prior to conducting the full-frame scan, the processing unit 36 may drive the first camera 34 to focus, if necessary.

Identifying the first microscopic image and marking the target area: The microprocessor 362 executes the image recognition software to identify the first microscopic image. Based on the identified image, at least one distribution area of the cells or tissues of the sample 92 is marked as the target area 94, and the first microscopic image is converted to the first digital file.

Area scanning: The processing unit 36 controls the motor 33 that drives the mount 32 to operate, positioning the second camera 35 toward the slide 90. The second camera 35 then scans the target area 94 of the slide 90 at the second magnification, obtaining the second microscopic image of the sample 92. The microprocessor 362 executes the image recognition software to identify the second microscopic image and converts it to the second digital file.

Slide return: The transfer device 20 places the scanned slide 90 back into the sample library 10.

The first and second digital files can be optionally transmitted through a transmission network to a remote data storage device or an interpretable remote device, enabling these remote devices to interpret the first and second digital files and display the corresponding first and second microscopic images. This provides relevant medical personnel or researchers with the ability to interpret the first and second microscopic images.

The first camera 34 scans the sample 92 at the lower first magnification to determine the target area 94, whereupon the second camera 35 scans the confirmed target area 94 at the higher second magnification, avoiding scanning areas outside of the target area 94. The resulting second microscopic image, which can be interpreted by medical personnel or researchers, is converted into the second digital file. The data size of this second digital file is significantly smaller than the digital files obtained by the prior art using the same second magnification for full-frame scanning. Despite the need to produce the first digital file converted from the first microscopic image in the present invention, the combined data size of the first and second digital files is still far less than the digital files obtained by the prior art scanning. For medical personnel or researchers, the primary object of interpretation is the second digital file, with only occasional review of the first digital file.

In the preferred embodiment, a full-frame scan is quickly executed at the lower first magnification, followed by a scan of the target area 94 at the higher second magnification. This approach reduces the overall time required to obtain images as compared to the prior art. The pixel count of the first and second microscopic images obtained is lower, and the time required to convert these images into the first and second digital files is less than the prior art. The data size of the resulting first and second digital files is also smaller than that of the prior art, which facilitates rapid microscopic scanning of a large number of slides 90 and copying and transmitting the first and second digital files.

The mount 32 is optionally connected to two linear rails 37, the motor 33 drives each of the linear rails 37 through each of the linear rails 37 so as to enable the mount 32 to reciprocate in a straight line, and the first camera 34 and the second camera 35 are disposed at intervals along the direction of this reciprocating motion of the mount 32.

The scanning device 30 further comprises a third camera 38, which is located on the side of the mount 32 facing the carrier 31 and is electrically connected to the microprocessor 362. However, the third camera 38 is a standard component familiar to those skilled in the art.

Based on the configuration of the third camera 38, the slide microscopic scanning method further comprises a high-magnification scanning step. Upon completion of the area scanning step, the high-magnification scanning step is conducted as necessary based on the content displayed by the second microscopic image, and then executed in the slide return step. The decision to conduct the high-magnification scanning step may occur when the processing unit 36 determines that the second microscopic image requires higher resolution analysis for further detail, possibly due to the smaller size of cell or nucleus features in the second microscopic image.

During the high-magnification scanning step, the processing unit 36 controls the motor 33 to activate the mount 32. The third camera 38 scans the target area 94 at a third magnification to obtain the third microscopic image of the sample 92. The microprocessor 362 executes image recognition software to identify the third microscopic image and convert it to a third digital file. The third magnification rate is higher than the second magnification rate, specifically selected to be 40× magnification.

The first camera 34, the second camera 35, and the third camera 38 are disposed at intervals along the direction of reciprocation of the mount 32, with the second camera 35 positioned between the first camera 34 and the third camera 38.

The digital slide micrographic scanning apparatus described herein further comprises an image store 40 consisting mainly of readable and writable storage media for storing the first digital file, the second digital file, and the third digital file. The image store 40 is electrically connected to the processing unit 36, whereby the processing unit 36 can transmit the first digital file, the second digital file, and the third digital file to the image store 40.

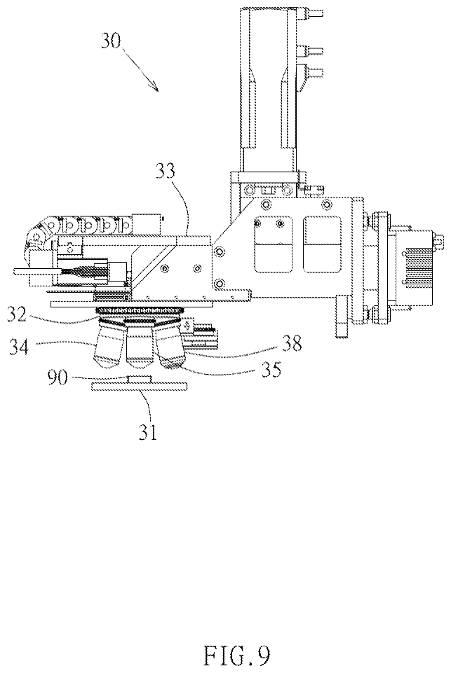

As shown in FIG. 9, another embodiment of the present invention differs mainly from the preferred embodiment in that the mount 32 is driven to rotate by the motor 33, and the first camera 34, the second camera 35, and the third camera 38 are arranged in a circular interval configuration on the side of the mount 32 facing the carrier 31.

I claim:

1. A digital slide microscopic scanning apparatus, comprising a sample library, a transfer device, and a scanning device, wherein:
the sample library is a storage device for holding multiple slides, each slide carrying a sample of micro-tissue;
the transfer device comprises a robotic arm assembly and a gripper, wherein one side of the robotic arm assembly faces the sample library and the gripper is located on the side of the robotic arm assembly facing the sample library; the robotic arm assembly operates the gripper to extract or insert a selected slide from/to the sample library and transfers the slide between the sample library and the scanning device;
the scanning device, located on one side of the robotic arm assembly, comprises a carrier, a mount, a motor, a first camera, a second camera, and a processing unit, wherein the carrier holds and positions the slide, the first and second cameras and the motor are electrically connected to the processing unit, and both the first and second cameras are located on the side of the mount facing the carrier so that the first and second cameras can respectively scan the slide and transmit the scanned images to the processing unit;
the motor drives the movement of the mount, allowing either the first camera or the second camera to be selectively activated for the purpose of scanning the slide;
the first camera conducts a full-frame scan of the slide at a first magnification to obtain a first microscopic image of the sample, the second camera subsequently conducts a scan of a specifically selected target area of the slide at a second magnification to obtain a second microscopic image of the sample, and these first and second microscopic images are then transmitted by the processing unit, wherein the first magnification is lower than the second magnification;
the processing unit comprises an electronic circuit having at least one microprocessor that executes image recognition software, determines the target area of the slide to be scanned by the second camera based on the first micrographic image, and converts the first micrographic image and the second micrographic image into a first digital file and a second digital file, respectively, in digital form.

2. The digital slide microscopic scanning apparatus according to claim 1, wherein the mount is connected to two linear rails, the motor drives each of the linear rails so as to enable the mount to reciprocate in a straight line, and the first camera and the second camera are disposed at intervals along the direction of the reciprocating motion of the mount.

3. The digital slide microscopic scanning apparatus according to claim 1, wherein the scanning device further comprises a third camera located on the side of the mount facing the carrier and electrically connected to the processing unit; wherein the processing unit selects the third camera to scan the target area of the slide at a third magnification higher than the second magnification based on the content of the second micrographic image, obtains a third micrographic image of the sample, and transmits the third micrographic image to the processing unit, which converts the third micrographic image into a third digital file in digital form.

4. The digital slide microscopic scanning apparatus according to claim 3, wherein the mount is connected to two linear rails, the motor drives each of the linear rails to reciprocate in a straight line, and the first camera, the second camera, and the third camera are disposed at intervals along the direction of the reciprocating motion of the mount, with the second camera positioned between the first camera and the third camera.

5. The digital slide microscopic scanning apparatus according to claim 3, further comprising an image store mainly comprising readable and writable storage media for storing the first digital file, the second digital file, and the third digital file; the image store is electrically connected to the processing unit, whereby the processing unit transmits the first digital file, the second digital file, and the third digital file to the image store.

6. The digital slide microscopic scanning apparatus according to claim 1, wherein each slide in the sample library is arranged in parallel to each other and at sequential intervals in a vertical direction.

7. A slide microscopic scanning method, performed using the digital slide microscopic scanning apparatus according to claim 1, comprising the following steps executed in sequence:
slide positioning: the transfer device selects a slide containing the sample from the sample library and transfers it to the carrier;
full-frame scanning: the first camera conducts a full-frame scan of the slide at a first magnification to obtain a first microscopic image of the sample;
identifying the first microscopic image and marking the target area: the microprocessor executes the image recognition software to identify the first microscopic image, at least one distribution area of the cells or tissues of the sample is marked as the target area based on the identified image, and the first microscopic image is converted to a first digital file;
area scanning: the processing unit controls the motor and the mount to operate the second camera, which scans the target area of the slide at a second magnification, obtaining a second microscopic image of the sample, then the processing unit executes the image recognition software to identify the second microscopic image and convert the second microscopic image into the second digital file; and
slide return: the transfer device places the scanned slide back into the sample library.

8. The slide microscopic scanning method according to claim 7, wherein:
the scanning device further comprises a third camera, the third camera being disposed on the underside of the mount, and the third camera being electrically connected to the processing unit; where the slide micrographic scanning method further comprises a high-magnification scanning step, wherein upon completion of the area scanning step, the processing unit determines the content of the second micrographic image, executes the high-magnification scanning step, and then executes the slide return step;
in the high-magnification scanning step, the processor controls the motor to activate the mount, and the third camera scans the target area at a third magnification, obtaining a third microscopic image of the sample, and the processing unit executes the image recognition software to identify the third microscopic image and convert the third microscopic image into a third digital file, the third magnification being higher than the second magnification.
